(19) United States
(12) Patent Application Publication
(10) Pub. No.: US 2013/0253708 A1
(43) Pub. Date: Sep. 26, 2013

(54) ADAPTIVE ENERGY MANAGEMENT SYSTEM FOR AN APPLIANCE

(71) Applicants: Robert Lafleur, Louisville, KY (US); Daryl C. Williams, Louisville, KY (US)

(72) Inventors: Robert Lafleur, Louisville, KY (US); Daryl C. Williams, Louisville, KY (US)

(21) Appl. No.: 13/429,866

(22) Filed: Mar. 26, 2012

(51) Int. Cl. G05D 23/00

(52) U.S. Cl. 700/276

(57) ABSTRACT

A system includes a meter, one or more sensors, a room air conditioner (RAC) comprising one or more power-consuming features/functions and a controller configured to control the one or more power-consuming features/functions. The system further includes an accessory computing device coupled with the RAC, the meter, and the one or more sensors. The accessory computing device is configured to receive and process a signal, and in response to the signal, instruct the RAC to operate in a particular operating mode. The particular operating mode may be an energy-management mode.

### BACKGROUND OF THE INVENTION

The present disclosure generally relates to energy management, and more particularly to energy management or demand supply management (DSM) of consumer appliances.

Generally, utilities charge a flat rate for their consumables, but as fuel prices increase and there is associated high energy usage during select parts of the day, utilities have become more sophisticated with regard to variable rates relating to the energy supplied to customers. More recently, various types of dynamic pricing, such as real-time energy pricing, have been introduced. Dynamic pricing provides market transparency that exposes customers to time variations in energy costs, encouraging customers to shift their electrical energy usage into periods of lower demand, and therefore, lower prices. Dynamic pricing is being increasingly used to mitigate power shortages and, in this context, it is referred to as a “demand response”. Utilities and their regulators have implemented demand response as programs, which provide incentives to reduce electrical demand during power shortages. In some cases, these incentives are contingent upon a customer reducing usage below some prescribed limit during each hour or each metering interval. Thus, operating a particular home appliance during the different rate periods can result in a substantial difference in energy costs to the user.

A conventional solution is to have automated responses or operating parameters for particular household appliances in response to different rates that an energy provider may charge. For example, during a peak period, rates may be classified as either “critical” or “high” and operation of the appliance may be terminated. On the other hand, where the energy rates are medium or low, operation of the appliance may proceed without alteration.

### BRIEF DESCRIPTION OF THE INVENTION

Embodiments of the invention configure one or more types of home appliances to operate in an energy saving mode.

In one aspect, a system includes a meter, one or more sensors, a room air conditioner (RAC) comprising one or more power consuming features/functions, a controller configured to control the one or more power consuming features/functions, and an accessory computing device coupled with the RAC, the meter, and the one or more sensors. The accessory computing device is configured to receive and process a signal, and in response to the signal, instruct the RAC to operate in a particular operating mode.

In another aspect, a room air conditioner (RAC) accessory computing device is provided. The accessory computing device including an interface module configured to receive wireless signals indicative of one or more commands to be executed by the RAC, a memory for storing the one or more commands, and a processor. The processor may be programmed to execute the one or more commands; and output a command that configures the RAC to operate in a particular operating mode.

In yet another aspect, a room air conditioner (RAC) is provided. The RAC includes one or more power consuming features/functions, a controller configured to control the one or more power consuming features/functions, and an accessory computing device coupled with the RAC. The accessory computing device is configured to receive and process a signal, and in response to the signal, output a command that configures the RAC to operate in a particular operating mode.

### BRIEF DESCRIPTION OF THE DRAWINGS

The present disclosure is described in detail below with reference to the attached figures.

FIGS. 1, 2 and 3 are schematic illustrations of an exemplary air conditioning system.

### DETAILED DESCRIPTION OF THE INVENTION

Embodiments of the invention provide a home appliance that is configured to operate in an energy saving mode. In one aspect, an air conditioning system includes incorporated logic, hardware, and software to dictate and control the operation of its components. Aspects of the present disclosure allow wireless writeable software to be incorporated into air conditioning systems, thereby enabling a “behavior” of the air conditioning system to be continuously tailored to changing household and utility conditions. However, while embodiments of the disclosure are illustrated and described herein with reference to modifying or incorporating wireless writeable software to an air conditioning system, and thus, enabling the modified air conditioning system to be adaptive to changing household and utility conditions, aspects of the disclosure are operable with any electrical energy-consuming system and/or type of electrical energy-consuming home appliance that includes a processor coupled with a memory which is configured to store wireless writeable software for access and execution by the processor.

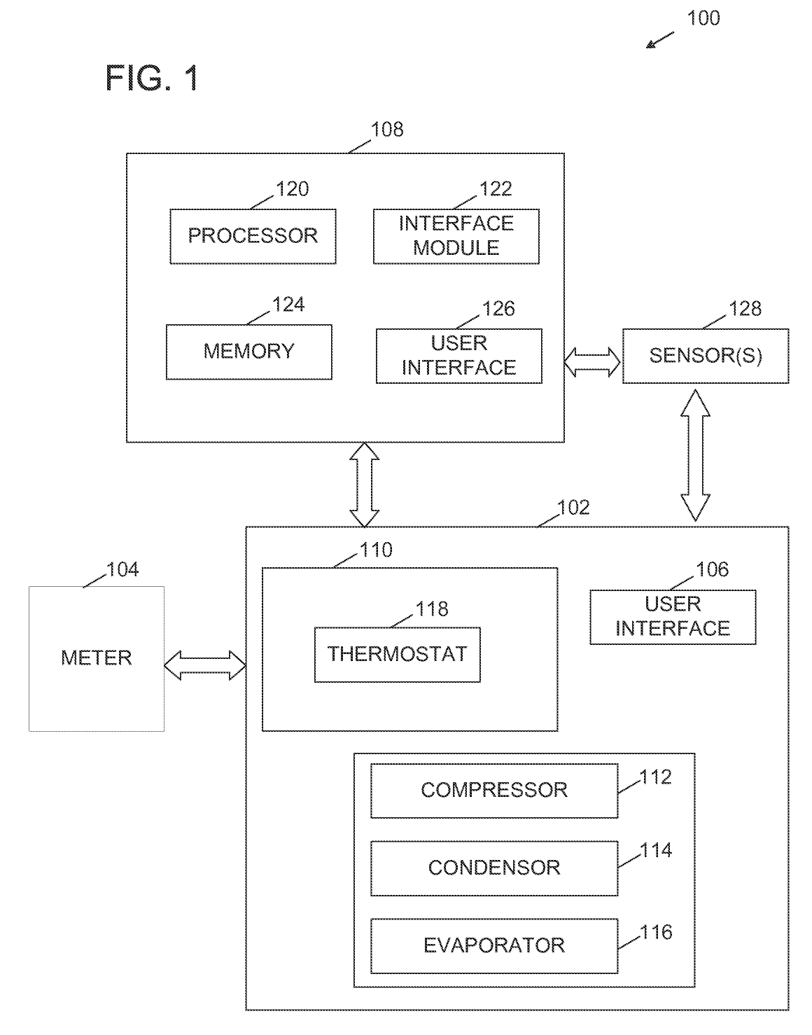

With reference to FIG. 1, a block diagram of an energy measurement system 100 is provided. Energy measurement system 100 includes a home appliance 102, which in one embodiment is an air conditioning system, such as a room air conditioner (RAC)), that includes one or more power consuming features/functions. Exemplary functions associated with a RAC may include at least one temperature controlling element for cooling (and optionally heating) air. The home appliance 102 may be coupled with one or more of a meter 104, which is configured to measure electric energy usage, a home area network (HAN) user interface 106, and an accessory computing device 108.

In one embodiment, an RAC cools the air, removes humidity, circulates air, filters out dust, and may also include a means for venting and heating. An RAC may be powered by a single phase electric current and which is an encased assembly designed as a unit for mounting in a window or through the wall for the purpose of providing delivery of conditioned air to an enclosed space. In one embodiment, home appliance 102 includes at least one temperature controlling element which is a refrigeration system including a set point temperature. The refrigeration system may be a closed loop system defining passages for a refrigerant fluid to flow. In one embodiment, home appliance 102 includes a controller 110 that controls the operation of energy measurement system 100 and a compressor 112, a condenser 114, and an evaporator 116, which may be disposed in a refrigerant flow relationship.

In a conventional air conditioning system, a thermostat controls the air conditioning system using dry bulb temperature alone. In the exemplary air conditioning system 102, a thermostat 118 is one module of controller 110 which controls the operation of energy measurement system 100. However, in other embodiments within the scope of the present disclosure, thermostat 118 is separate from, but still in communication with controller 110.

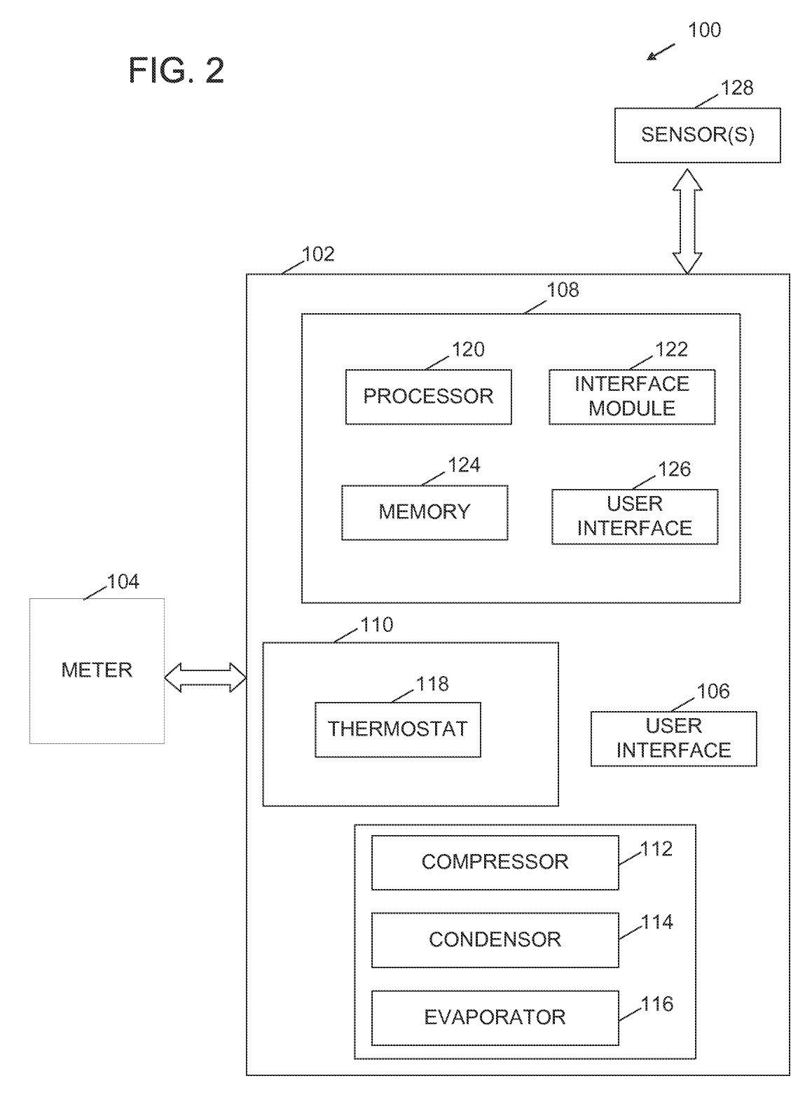

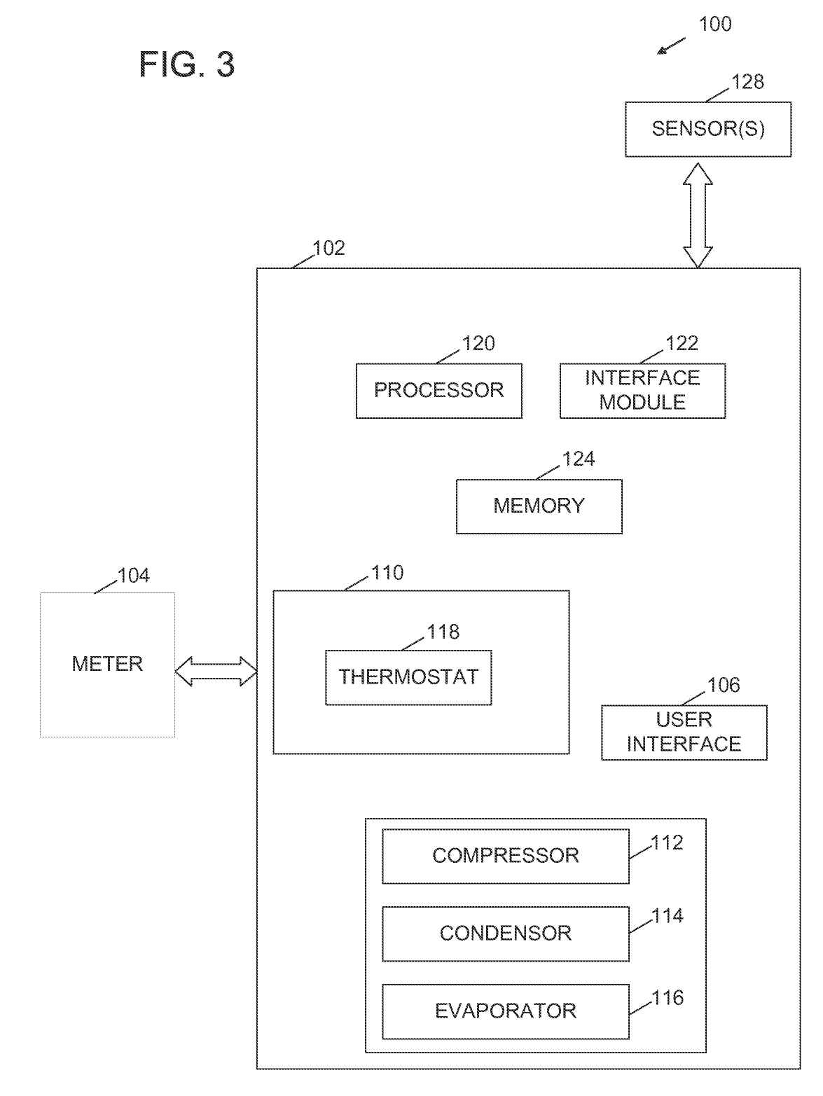

Embodiments of the disclosure enable home appliance 102 to be coupled with accessory computing device 108 which enables wireless writeable software to be incorporated into home appliance 102 thus enabling a “behavior” of home appliance 102 to be continuously tailored to changing household and utility conditions. In one embodiment, accessory computing device 108 includes a processor 120 coupled with an interface module 122 and a memory 124. Accessory computing device 108 may be separate from (e.g., connected via wires and not physically attached) (see FIG. 1) or removably attached to (e.g., physically in contact with) (see FIG. 2) home appliance 102. For example, in one embodiment, accessory computing device 108, and its components, is in the form of a printed circuit board (PCB). This PCB may be incorporated directly into home appliance 102 via standard hardware connections and input/output protocols. Alternatively, one or more of the processor 120, interface module 122, and memory 124 may be separately coupled with the RAC (see FIG. 3).

Accessory computing device 108 is coupled with controller 110 and one or more sensors 128. Accessory computing device 108 may communicate with user interface 106, controller 110, and one or more sensors 128 via wired and/or wireless networks, for example, local area networks or global networks such as the Internet. In embodiments in which accessory computing device 108 communicates using wireless networks, each of accessory computing device 108, one or more sensors 128, and controller 110 may be enabled with technology such as BLUETOOTH® brand wireless communication services (secured or unsecured), radio frequency identification (RFID), Wi-Fi such as peer-to-peer Wi-Fi, ZIGBEE® brand wireless communication services, near field communication (NFC), and other technologies that enable short-range or long-range wireless communication. In some embodiments, each of accessory computing device 108, one or more sensors 128, and controller 110 may communicate via a wireless cellular network providing Internet access.

In one embodiment, user interface 106 may be a capacitive touch screen display configured to be responsive to a user pressing contact on a screen to selectively perform functionality. Thus, a user can operate the desired functions, and/or set and/or alter one or more set points, by contacting a surface of the control panel/user interface 106 as well as other functions provided herein.

As mentioned above, accessory computing device 108 enables home appliance 102 to be periodically or continuously tailored to changing household and/or utility conditions. For example, home appliance 102 may receive a signal via interface module 122 instructing home appliance 102 to operate in one of a plurality of operating modes, including, for example, a normal operating mode, and an energy saving (i.e., energy management) mode. In one embodiment, the operating mode may be a particular operating mode, which is not an operating mode of the RAC that is available prior to receiving the signal. The particular operating mode may be an energy management (i.e., energy-saving) mode.

For example, the RAC may enter a load shedding mode in which a processor coupled therewith calculates a reduced percent run time. This reduced percent run time may accommodate the desired amount of load to be shed as required by the demand response signal. It should be appreciated that accessory computing device 108 can be configured with default settings that govern the energy management mode and the normal operation mode. In one embodiment, a mode, such as an energy management mode, may be user-defined. One or more settings in each type of operating mode can be fixed while others may be adjustable to user preference.

For example, the meter 104 may output a demand response signal to controller 110. As used herein, the term “demand response signal” refers to a signal received directly or indirectly from an energy provider, which signal that conveys information that may cause a consumer to want to change power consumption of one or more appliances. For example, the signal may convey information indicating a high cost period, a low cost period, one or more intermediate cost periods, a peak demand period, an off-peak demand period, a high demand period, a low demand period, and/or one or more intermediate demand periods. Interface module 122 is configured to enable accessory computing device 108 to receive a signal (e.g., a ZIGBEE® transmission) from meter 104 or from a home energy management controller and then forward control intelligence to air conditioning system 102. However, if accessory computing device 108 is external from air conditioning system 102, interface module 122 is configured to forward intelligence to a control board of home appliance 102 through, for example, a wired connection. A typical example of such a wired connection is a CATS cable incorporating RJ45 connectors and linking the external ZIGBEE brand module to an appliance. One of ordinary skill in the art guided by the teachings herein will appreciate that other communication protocols can be used and the present disclosure should not be limited to any particular communication format.

In one embodiment, a demand response signal may be received by interface module 122 from meter 104 enabling processor 120 to output a command to controller 110 with respect to how many degrees Fahrenheit (° F.) to increase a set point from a set point defined by a user or in response to an energy demand on the utility. For example, if a signal indicative of a “high” or “critical” status is received from meter 104, then processor 120 can access a look-up table in memory 124 and the software implemented on accessory computing device 108 to, for example, institute a percentage increase or change the temperature set point a certain amount based on information provided in the signal.

In one embodiment, accessory computing device 108 includes a user interface 120 that enables a user to set and/or alter set points. One or more of these set points may be provided by a manufacturer or an energy provider. In one embodiment, user interface 120 may be a capacitive touch screen display configured to be responsive to a user pressing contact on a screen to selectively perform functionality. Thus, a user can operate the desired functions by contacting a surface user interface 120 as well as other functions provided herein.

Another potential response action is to initiate a percentage load reduction and a specified length of time for the reduction. If only a minimum load reduction is specified, the appliance (e.g., an RAC) may change a fan speed to a lower fan speed and maintain a current cycling pattern of compressor 112 if it is determined that this action alone meets the load reduction requirement. In the energy savings mode, energy savings will continue until a specified amount of time is met at which point home appliance 102 assumes normal operation. In one embodiment, accessory computing device 108 may output a command that causes a complete shutdown of operation or a switch to a low fan speed for a pre-determined period of time.

In one embodiment, accessory computing device 108 may be configured to receive a demand response signal from the meter 104. The received demand response signal may enable a signal from an energy provider to take precedence over any preprogrammed mode (e.g., an energy management mode) in the air conditioning system 102. However, when the energy provider relinquishes control, then the energy management mode takes precedence. For example, accessory computing device 108 or home appliance 102 is capable of storing user defined program set point information during different periods during the day. One common example of an energy management mode, is a seven (7) day program with four (4) different time periods during the day in which the time periods and associated setpoint temperatures are selected, or programmed by the user. The user can also temporarily override these programming selections by manually selecting a different set point (suspending programmed operation until the next occurring programmed time period) or can be canceled at any time. As will be appreciated, the user may create many distinct or individual programs for each day, or programs may be applied to groups of days (e.g., one group for operation on week days), and a different program selected for weekend operation.

In an exemplary order of mode priority for response to a DSM signal from an energy provider, if the air conditioner is off, then no action is taken. Secondly in priority, to avoid damage to the compressor, if the compressor has either been “on” for less than a predetermined time period (e.g., less than three (3) minutes) or “off” for less than a predetermined period of time (e.g., three (3) minutes), then the compressor must continue that state until the predetermined time period (three (3) minutes) has elapsed. Thirdly in priority, if the temperature is above a predetermined temperature, e.g., 85° F., then the DSM signal may be ignored. In addition, the response may be dictated by a utility meter signal. Next in priority, the air conditioner operates based on a defined program in the home energy manager or the seven (7) day unit programming. Finally, all operating modes of the air conditioner can be overridden by the user at any given point in time. For example, by pressing and holding a button for a predetermined amount of time or pressing multiple buttons at the same time or in a predetermined sequence. Such actions may cause an audible and/or visual notification to be generated that confirms the user acknowledges that they are overriding an energy saving mode and thus may not receive all the energy savings benefits.

### Exemplary Operating Environment

A controller or computing device such as is described herein has one or more processors or processing units, system memory, and some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal, such as a carrier wave or other transport mechanism, and include any information delivery media. Combinations of any of the above are also included within the scope of computer readable media.

The controller/computer may operate in a networked environment using logical connections to one or more remote computers, such as a remote computer. Although described in connection with an exemplary computing system environment, embodiments of the present disclosure are operational with numerous other general purpose or special purpose computing system environments or configurations. The computing system environment is not intended to suggest any limitation as to the scope of use or functionality of any aspect of the present disclosure. Moreover, the computing system environment should not be interpreted as having any dependency or requirement relating to any one or combination of components illustrated in the exemplary operating environment. Examples of well known computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the present disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the present disclosure may be implemented with any number and organization of such components or modules. For example, aspects of the present disclosure are not limited to the specific computer-executable instructions or the specific components or modules illustrated in the figures and described herein. Other embodiments of the present disclosure may include different computer-executable instructions or components having more or less functionality than illustrated and described herein. Aspects of the present disclosure may also be practiced in distributed computing environments where tasks are performed by remote processing devices that are linked through a communications network. In a distributed computing environment, program modules may be located in both local and remote computer storage media including memory storage devices.

Aspects of the present disclosure transform a general-purpose computer into a special-purpose computing device when configured to execute the instructions described herein.

The order of execution or performance of the operations in embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

When introducing elements of aspects of the present disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

This written description uses examples to disclose the claimed subject matter, including the best mode, and also to enable any person skilled in the art to practice the claimed subject matter, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a meter;
one or more sensors;
a room air conditioner (RAC) comprising one or more power consuming features/functions and a controller configured to control the one or more power consuming features/functions; and
an accessory computing device coupled with the RAC, the meter, and the one or more sensors, the accessory computing device configured to receive and process a signal, and in response to the signal, instruct the RAC to operate in a particular operating mode.

2. The system of claim 1, wherein the accessory computing device comprises:
a processor;
an interface module configured to receive wireless signals indicative of one or more commands to be executed by the processor and/or the RAC; and
a memory configured to store the one or more commands.

3. The system of claim 2, wherein at least one of the the processor, the interface module, and the memory is located on a printed circuit board that is incorporated directly into the RAC via standard hardware connections and input/output protocols.

4. The system of claim 2, wherein at least one of the processor, the interface module, and the memory is separately coupled with the RAC.

5. The system of claim 2, wherein the accessory computing device further comprises a user interface that enables set points to be set and/or altered.

6. The system of claim 5, wherein the user interface is a capacitive touch screen display.

7. A room air conditioner (RAC) accessory computing device comprising:
an interface module configured to receive wireless signals indicative of one or more commands to be executed by the RAC;
a memory configured to store the one or more commands; and
a processor programmed to:
execute the one or more commands; and
output a command that configures the RAC to operate in a particular operating mode.

8. The RAC accessory computing device of claim 7, wherein each of the processor, the interface module, and the memory are located on a printed circuit board.

9. The RAC accessory computing device of claim 7, wherein the accessory computing device further comprises a user interface that enables a user to set and/or alter one or more set points.

10. The RAC accessory computing device of claim 9, wherein the user interface is a capacitive touch screen display.

11. The RAC accessory of claim 7, wherein the user interface receives a signal causing the processor to instruct the RAC to operate in the particular operating mode.

12. The RAC accessory of claim 11, wherein the particular operating mode was not a mode of the RAC prior to receiving the command output from the processor.

13. A room air conditioner (RAC) having one or more power-consuming features, the RAC comprising:
a controller configured to control one or more power-consuming features; and
an accessory computing device coupled with the RAC, the accessory computing device configured to receive and process a signal, and in response to the signal, output a command that configures the RAC to operate in a particular operating mode.

14. The RAC of claim 13, wherein the accessory computing device, comprises:
a processor;
an interface module coupled with the processor and configured to receive wireless signals indicative of one or more commands to be executed by the processor and/or the RAC; and
a memory coupled with the processor and configured to store the one or more commands.

15. The RAC of claim 14, wherein each of the processor, the interface module, and the memory are located on a printed circuit board.

16. The RAC of claim 14, wherein at least one of the processor, the interface module, and the memory is separately coupled with the RAC.

17. The RAC of claim 14, wherein the accessory computing device further comprises a user interface that enables a user to set and/or alter one or more set points.

18. The RAC of claim 17, wherein the user interface is a capacitive touch screen display.
